(19) United States
(12) Patent Application Publication
(10) Pub. No.: US 2010/0197228 A1
(43) Pub. Date: Aug. 5, 2010

(54) CLOCK SYNCHRONIZATION METHOD FOR A SHORT RANGE WIRELESS COMMUNICATION NETWORK

(75) Inventors: Mingxing Dong, Beijing (CN); Yong Guan, Beijing (CN)

Correspondence Address: TUROCY & WATSON, LLP, 127 Public Square, 57th Floor, Key Tower, CLEVELAND, OH, 44114, US

(73) Assignee: BEIJING TRANSPACIFIC IP TECHNOLOGY DEVELOPMENT LTD, BEIJING (CN)

(21) Appl. No.: 12/600,907

(22) PCT Filed: May 22, 2008
(86) PCT No.: PCT/CN08/71051

§ 371 Date: Apr. 13, 2010

(30) Foreign Application Priority Data
May 24, 2007 (CN) 200710099542.9

(51) Int. Cl. H04B 7/005

(52) U.S. Cl. 455/41.2

(57) ABSTRACT

A clock synchronization method includes: A) configuring a device to determine a time interval between issuance of a command by a network coordinator and the completion of the transmission of a (SFD) of a beacon frame by the network coordinator; B) upon completion of the reception of the SFD byte of the beacon frame by the device, configuring the device to generate a synchronization signal; C) in response to the synchronization signal, configuring the device to record a first clock time thereof; D) upon completion of the reception of the beacon frame by the device, configuring the device to record a second clock time thereof; E) configuring the device to calculate a synchronization clock time based on the time interval, and the first and second clock times; and F) configuring the device to adjust a clock time thereof to the synchronization clock time.

### CROSS-REFERENCE TO RELATED APPLICATION

This application claims priority of Chinese Application No. 2008071051, filed on May 22, 2008.

### BACKGROUND OF THE INVENTION

1. Field of the Invention

This invention relates to a clock synchronization method, more particularly to a clock synchronization method for a short range wireless communication network.

2. Description of the Related Art

In a Zigbee network, there are two kinds of nodes: network coordinator and device. The ZigBee network operates in two communication modes: non-beacon mode and beacon mode.

In the non-beacon mode, the network coordinator does not send a beacon frame, each device accesses a channel using a non-slotted CSMA/CA mechanism and operates with reference to a local clock, and there is no network clock.

In the beacon mode, the network coordinator periodically sends a superframe to coordinate communication among the devices in the network. FIG. 1 illustrates a superframe structure. The superframe is divided into periods. The network coordinator determines an operating state of the network in each period of a current superframe based on a request and an operating state of each of the devices in the previous superframe. A superframe starts with the network coordinator transmitting a beacon frame. The network coordinator broadcasts the beacon frame periodically. The beacon frame contains duration of a superframe and timing allocation information. After receiving the beacon frame, the device determines an operation thereof based on the content of the beacon frame, such as to enter a sleep state and to remain at the sleep state until the end of the beacon frame.

In the beacon mode, since the network coordinator defines the operating state of the network in each period of a superframe in a particularly strict manner, the device must be synchronized with the network coordinator so as to be able to make arrangement of operations thereof based on the beacon frame, and so as to be able to communicate with one of the nodes of the network without interfering with the other nodes. For example, when the network coordinator has already entered an inactive period while the device is still operating in a contention period, the communication between the network coordinator and the device will fail. The device and the network coordinator are synchronized when clock times of local clocks of the devices and the network coordinator are kept the same or within an allowable time error range. The whole network operates normally and efficiently under the control of the network coordinator only when the local clocks of the network coordinator and the device are synchronized.

The synchronization among the local clocks of the nodes in the network can be attributed to two main factors: effectiveness of a synchronization method and accuracy of a local clock.

Network Time protocol (NTP) or a simplified version thereof is a commonly used synchronization method. However, the Zigbee network has a limited bandwidth, and since the NTP takes up a large amount of network and hardware resources, such synchronization method affects efficiency of network communication. Moreover, since the synchronization method can only be implemented in the application layer or the network layer, which is relatively complicated for IEEE 802.15.4-2006, such synchronization method is not suitable for the Zigbee network.

A crystal oscillator is the key component that determines the accuracy of a local clock. A general purpose crystal oscillator is inexpensive but inaccurate. The general purpose crystal oscillator has an accuracy of only about ±20 ppm. Even when initially set accurately, after one second, clock times between a pair of local clocks will differ by a time error of 40us due to the inaccuracy of the crystal oscillator. The time error increases as time passes. One way to minimize the time error is to use a high precision crystal oscillator. The high precision crystal oscillator, however, is expensive, and is therefore not suitable for a low cost Zigbee network.

### SUMMARY OF THE INVENTION

Therefore, the main object of the present invention is to provide a clock synchronization method for a short range wireless communication network that can overcome the aforesaid drawbacks of the prior art.

According to the present invention, there is provided a clock synchronization method for a short range wireless communication network that includes a network coordinator and a device. The network coordinator includes a micro-controller configured to issue a beacon frame transmit command, and a wireless transceiver chip configured to transmit a beacon frame to the device in response to the beacon frame transmit command. The clock synchronization method comprises: A) configuring the device to determine a time interval between the issuance of the beacon frame transmit command by the micro-controller of the network coordinator and the completion of the transmission of a start of frame delimeter (SFD) of the beacon frame by wireless transceiver chip of the network coordinator; B) upon completion of the reception of the SFD byte of the beacon frame by a wireless transceiver chip of the device, configuring the wireless transceiver chip of the device to generate a synchronization signal; C) in response to the synchronization signal, configuring a micro-controller of the device to record a first clock time of a local clock of the device; D) upon completion of the reception of the beacon frame by the wireless transceiver chip of the device, configuring the micro-controller of the device to record a second clock time of the local clock of the device; E) configuring the micro-controller of the device to calculate a synchronization clock time based on the time interval determined in step A), the first clock time recorded in step C), and the second clock time recorded in step D); and F) configuring the micro-controller of the device to adjust the local clock of the device to the synchronization clock time calculated in step E).

### BRIEF DESCRIPTION OF THE DRAWINGS

Other features and advantages of the present invention will become apparent in the following detailed description of the preferred embodiments with reference to the accompanying drawings, of which:

FIG. 1 is a timing diagram illustrating a superframe transmitted by a conventional network coordinator; and

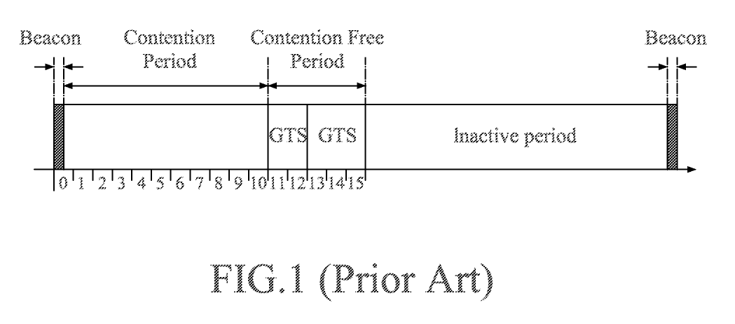

FIG. 2 is a timing diagram illustrating synchronization signals generated by a device according to the present invention.

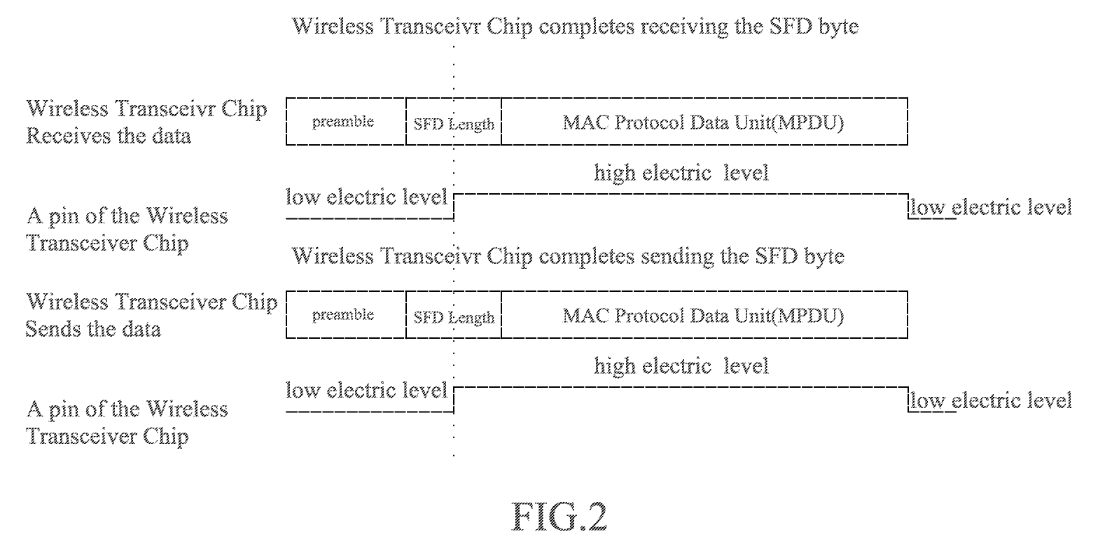

### DETAILED DESCRIPTION OF THE PREFERRED EMBODIMENT

The preferred embodiment of a clock synchronization method for a short range wireless communication network according to this invention is implemented using a network coordinator and a device. Initially, a micro-controller of the network coordinator issues a beacon frame transmit command to a wireless transceiver chip of the network coordinator. Then, in response to the beacon frame transmit command, the wireless transceiver chip of the network coordinator transmits a beacon frame to the device. Subsequently, a micro-controller of the device determines a time interval between issuance of the beacon frame transmit command by the micro-controller of the network coordinator and the completion of the transmission of a start of frame delimeter (SFD) byte of the beacon frame by the wireless transceiver chip of the network coordinator. Upon completion of the reception of the SFD byte of the beacon frame by a wireless transceiver chip of the device, the wireless transceiver chip of the device generates a synchronization signal that rises from a low electric level to a high electric level. In response to the synchronization signal, the micro-controller of the device records a first clock time of a local clock of the device. Upon completion of the reception of the beacon frame by the wireless transceiver chip of the device, the micro-controller of the device records a second clock time of the local clock of the device. The micro-controller of the device calculates a synchronization clock time based on the time interval determined thereby, and the first and second clock times recorded thereby. Finally, the micro-controller of the device adjusts the local clock of the device to the synchronization clock time calculated thereby.

In this embodiment, the micro-controller of the device calculates the synchronization clock time (F) using the equation

F=F1+(F3−F2)

where F1 is the time interval determined by the micro-controller of the device, F2 is the first clock time recorded by the micro-controller of the device, and F3 is the second clock time recorded by the micro-controller of the device.

The wireless transceiver chip (a.k.a. RF) of the network coordinator provides a synchronization signal through a pin thereof when transmitting a SFD byte of a data frame. On the other hand, the wireless transceiver chip of the device provides a synchronizing signal through a pin thereof when receiving a SFD byte of a data frame. For example, when the network coordinator transmits a data frame to the device, when the wireless transceiver chip of the network coordinator completes transmission of the SFD byte of the data frame, the wireless transceiver chip of the network coordinator provides through the pin thereof a synchronization signal. When the device receives the SFD byte of the data frame transmitted thereto by the network coordinator, the wireless transceiver of the device also provides through the pin thereof a synchronization signal. The speed of the wireless electromagnetic is relatively fast, i.e., 30 Km/s. As such, the transmission delay between the network coordinator and the device is negligible. Therefore, it can be assumed that the completion of the transmission of the SFD byte by the network coordinator and the reception of the SFD byte by the device occurs at the same time. It is noted that since the time interval (F1) is fixed, the device is may calculate the interval (F1) based on the synchronization signal. In a beacon mode, each superframe starts with the network coordinator transmitting a beacon frame. As such, after the local clock of the device is adjusted to the synchronization clock time (F), the local clock of the device network coordinator and the device is synchronized with the local clock of the network coordinator. Moreover, the device adjusts the local clock thereof each time a beacon frame is received. As such, the difference, time error, accumulated between clock times of the local clocks of the network coordinator and the device can be controlled within an allowable time error range.

One factor that causes the time error between the clock times of the local clocks of the network coordinator and the device is when the local clocks of the network coordinator and the device start at different times. Another factor that causes the time error between the local clocks of the network coordinator and the device is when the accuracy of the crystal oscillator of the local clock of the network coordinator differs from that of the crystal oscillator of the local clock of the device. For instance, while the local clocks both use a 16 MHz±20 ppm crystal oscillator, one of the crystal oscillators may actually be operating at 16 MHz+160 Hz, and the other of the crystal oscillator may actually be operating at 16 MHz−160 Hz. This difference accumulates over time. In the Zigbee network, the network coordinator periodically broadcasts a beacon. After receiving the beacon, the device adjusts the local clock thereof to thereby synchronize the local clock thereof with the local clock of the network coordinator, and does not adjusts the lock clock thereof prior to receipt of the next beacon. It is noted that when the time interval between the beacons is long, that is, when the length of the superframe is long, the synchronization between the network coordinator and the device in the first half of the superframe is maintained. However, in the last half of the superframe, the difference between the clock times of the local clocks of the network coordinator and the device accumulates. As such, when a low precision crystal oscillator is used, in order to maintain the time error between clock times of the local clocks of the network coordinator and device within an allowable range, the beacon order must not be set too high.

For example, when the local clocks of the network coordinator and the device both use a 16 M±20 ppm crystal oscillator and are started at the same time, after four seconds, the difference, time error, accumulated between the local clocks of the network coordinator and the device is thus 160us (or lower). Moreover, when an error 10us, test value, in clock synchronization adjustment operation, is added to the clock time of each of the local clocks, the time error between the local clocks, after four seconds, is 180us, which is within an allowable time error range of the Zigbee network. When the length of a superframe is approximately four seconds, the beacon order must be equal to or less than eight. On the other hand, when the beacon order is equal to or greater than nine, the time error can be as high as 320us, which is beyond the allowable time error range of the Zigbee network. Therefore, when a low precision crystal oscillator is used, the present invention is applicable only for beacon orders equal to or less than eight. On the other hand, However, when a high precision crystal oscillator is used, the present invention is applicable for beacon orders equal to or greater than nine.

In this embodiment, the micro-controller is a C8051F121 type micro-controller. Moreover, in this embodiment, the wireless transceiver chip is a CC2420 type transceiver chip.

Based on experimental results, the present invention achieves a satisfactory performance in the Zigbee network.

In the present invention, the hardware for detecting interrupts is implemented using simply a programmable counter array (PCA), e.g., C8051F121. Moreover, in the present invention, the firmware for enabling the PCA to detect interrupts is implemented with only a hundred lines of codes. Further, since the present invention employs the beacon frame for synchronizing the local clocks, the present invention does not occupy a bandwidth of the network. Still further, since the value to which the local clock is adjusted can be calculated using a simple equation, i.e., without involving a complicated protocol, the present invention is relatively easy to maintain.

While the present invention has been described in connection with what are considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A network clock synchronization method of short range wireless communication network, the steps of the method comprising:
a micro controller of a coordinator in the short range wireless communication network sending a beacon frame transmit command to a local wireless transceiver chip, and after the beacon frame being received, the wireless transceiver chip sending the beacon frame to a normal device, and computing a time F1 used during the command transmission and the completion of the transmission of a synchronization begin byte in the beacon frame by the wireless transceiver chip;
after receiving the synchronization begin byte in the beacon frame by the wireless transceiver chip of the normal device, the wireless transceiver chip sending an alter signal of altering from a low electric level to a high electric level to the local micro controller, and the local micro controller recording a current time F2 of a local clock after receiving the alter signal; and
the normal device recording a current time F3 of the local clock after receiving the complete beacon frame, and based on the F1, the F2 and the F3, a newest current time of the local clock=F1+(F3−F2), and updating the current time with the newest current time.

2. A clock synchronization method for a short range wireless communication network that includes a network coordinator and a device, the network coordinator including a micro-controller configured to issue a beacon frame transmit command, and a wireless transceiver chip configured to transmit a beacon frame to the device in response to the beacon frame transmit command, said clock synchronization method comprising:
A) configuring the device to determine a time interval between the issuance of the beacon frame transmit command by the micro-controller of the network coordinator and the completion of the transmission of a start of frame delimiter (SFD) of the beacon frame by wireless transceiver chip of the network coordinator;
B) upon completion of the reception of the SFD byte of the beacon frame by a wireless transceiver chip of the device, configuring the wireless transceiver chip of the device to generate a synchronization signal;
C) in response to the synchronization signal, configuring a micro-controller of the device to record a first clock time of a local clock of the device;
D) upon completion of the reception of the beacon frame by the wireless transceiver chip of the device, configuring the micro-controller of the device to record a second clock time of the local clock of the device;
E) configuring the micro-controller of the device to calculate a synchronization clock time based on the time interval determined in step A), the first clock time recorded in step C), and the second clock time recorded in step D); and
F) configuring the micro-controller of the device to adjust the local clock of the device to the synchronization clock time calculated in step E).

3. The clock synchronization method of claim 2, wherein the synchronization clock time (F) is calculated in step E) using the equation
F=F1+(F3−F2)
where F1 is the time interval determined in step A), F2 is the first clock time recorded in step C), and F3 is the second clock time recorded in step D).
